(19) United States
(12) Patent Application Publication
(10) Pub. No.: US 2026/0361995 A1
(43) Pub. Date: Nov. 12, 2026

(54) SYSTEMS AND METHODS FOR IMAGE CAPTURE FEEDBACK

(71) Applicant: Apple Inc., Cupertino, CA (US)

(72) Inventor: Manuel C. CLEMENT, Felton, CA (US)

(21) Appl. No.: 19/662,272

(22) Filed: Apr. 29, 2026

Related U.S. Application Data
(60) Provisional application No. 63/802,922, filed on May 9, 2025.

(51) Int. Cl. H04N 23/60; H04N 23/61; H04S 7/00

(52) U.S. Cl. CPC H04N 23/64; H04N 23/61; H04S 7/304; H04S 2400/11

(57) ABSTRACT

In some examples, a wearable device that includes an input device, an output device, one or more processors, and memory detects an object in a physical environment and perform an action associated with the object. In some examples, the wearable device captures an image of the physical environment that includes the object. In some examples, the wearable device determines whether the captured image satisfies one or more first criteria related to the object. In some examples, if the one or more first criteria are not met, the wearable device provides a first prompt to guide the user to adjust the input device's orientation toward the object. In some examples, if the one or more first criteria are met, a second prompt is issued, confirming that the input device is correctly directed at the object, and the wearable device then performs the action associated with the object.

### CROSS-REFERENCE TO RELATED APPLICATIONS

This application claims the benefit of U.S. Provisional Application No. 63/802,922 filed May 9, 2025, the content of which is incorporated herein by reference in its entirety for all purposes.

### FIELD OF THE DISCLOSURE

This disclosure relates generally to a wearable device, and more particularly, to a wearable device including an input device and an output device configured to prompt a user to direct the input device towards an object in a physical environment.

### BACKGROUND OF THE DISCLOSURE

Aspects of this disclosure relate to wearable devices with image-capturing capabilities. These devices are commonly used for tasks in fields such as extended reality, manufacturing, and healthcare. However, improperly aligning the input device, such as a camera, with objects of interest, can lead to inaccurate or incomplete data capture or failed operations.

### SUMMARY OF THE DISCLOSURE

This disclosure describes a wearable device equipped with an input device, such as a camera, and an output device, such as one or more speakers. This system detects, via the input device, an object of interest in a physical environment and directs a user of the wearable device, via the output device, to align the input device with the object of interest and perform an action associated with the object. By guiding the user to align the input device with the object of interest, the system improves positioning of the input device relative to the object, enabling the input device to capture more reliable visual data of the object of interest. This design improves the accuracy of the detection of the object of interest in the physical environment and, as a result, improves the accuracy and efficiency of the action performed associated with the object. In addition, directing the user through audio feedback allows the system to assist in positioning the wearable device without requiring the user to visually monitor a display, thereby enabling hands-free operation while maintaining accurate detection of the object of interest. Thus, the guidance herein improves the efficiency and ease of interactions for an improved user experience.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the scope of the disclosure.

### BRIEF DESCRIPTION OF THE DRAWINGS

For a better understanding of the various described examples, reference should be made to the Detailed Description below, in conjunction with the following drawings in which like reference numerals refer to the corresponding parts throughout the figures.

FIGS. 1A-1B illustrate block diagrams of example architectures for electronic devices according to some examples of this disclosure.

FIG. 1C illustrates an example of a wearable device that is or includes a pair of headphones according to some examples of this disclosure.

FIG. 2A illustrates an example of a wearable device detecting a user input within a physical environment according to some examples of this disclosure.

FIG. 2B illustrates an example of the wearable device providing one or more prompts to the user in response to capturing a portion of an object in the physical environment according to some examples of this disclosure.

FIG. 2C illustrates an example of the user directing the wearable device towards the object within the physical environment, providing a prompt, and performing an action associated with the object according to some examples of this disclosure.

FIG. 2D illustrates an alternative example of the wearable device detecting the user input where the object is outside the field of view of the wearable device according to some examples of this disclosure.

FIG. 2E illustrates an example of the user directing the wearable device in response to the one or more prompts according to some examples of this disclosure.

FIG. 2F illustrates an example of the wearable device providing a prompt to direct the user to reposition the wearable device according to some examples of this disclosure.

FIG. 2G illustrates an alternative example of the user directing the wearable device towards the object within the physical environment, providing a prompt, and performing the action associated with the object according to some examples of this disclosure.

FIG. 3 illustrates an example method of directing an input device at an object in the physical environment and performing an action associated with the object according to some examples of this disclosure.

### DETAILED DESCRIPTION

In the following description of examples, reference is made to the accompanying drawings which form a part hereof, and in which it is shown by way of illustration specific examples that can be practiced. It is to be understood that other examples can be used, and structural changes can be made without departing from the scope of the disclosed examples.

This disclosure describes a wearable device equipped with an input device, such as a camera, and an output device, such as one or more speakers. This system detects, via the input device, an object of interest in a physical environment and directs a user of the wearable device, via the output device, to align the input device with the object of interest and perform an action associated with the object. By guiding the user to align the input device with the object of interest, the system improves positioning of the input device relative to the object, enabling the input device to capture more reliable visual data of the object of interest. This design improves the accuracy of the detection of the object of interest in the physical environment and, as a result, improves the accuracy and efficiency of the action performed associated with the object. In addition, directing the user through audio feedback allows the system to assist in positioning the wearable device without requiring the user to visually monitor a display, thereby enabling hands-free operation while maintaining accurate detection of the object of interest.

In some examples, one or more features described herein may be implemented using artificial intelligence (AI) and/or machine learning (ML) techniques. As used herein, “artificial intelligence” refers to computational processes and systems configured to perform tasks that typically require human intelligence, including but not limited to perception, pattern recognition, classification, prediction, decision-making, natural language processing, and contextual understanding. Such AI and/or ML techniques may include, without limitation, machine learning models (e.g., supervised, unsupervised, semi-supervised, and reinforcement learning models), neural networks (e.g., deep neural networks, convolutional neural networks, recurrent neural networks, transformers), and other statistical or algorithmic models capable of learning from data and improving performance over time. These models may be trained on data captured by one or more sensors of an electronic device (e.g., camera images, video, audio, or metadata) or external data sources, and may be used to automatically identify, extract, interpret, or generate information. Accordingly, the systems and methods described herein may leverage AI and/or ML to enable a wide variety of automated or semi-automated functionalities, including, for example, extracting text from images, recognizing objects or scenes, associating captured content with contextual information, and initiating or modifying device operations based on such analysis. In some examples, when referring to one or more actions performed by the electronic device, this refers to the electronic device utilizing AI and/or ML to perform various camera-based tasks as described in further detail herein.

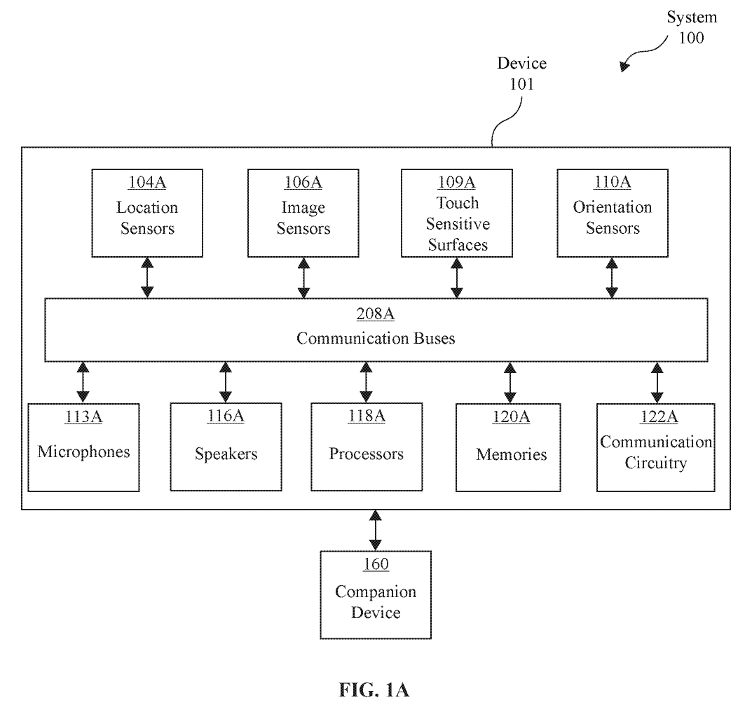

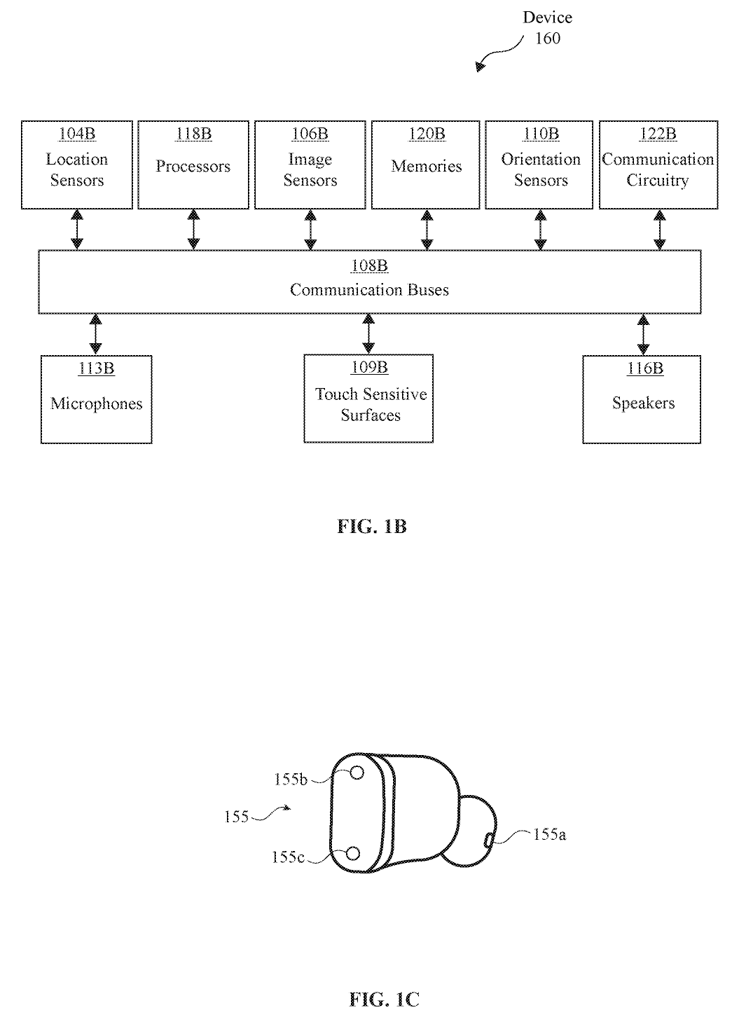

FIGS. 1A-1B illustrate block diagrams of example architectures for electronic devices according to some examples of this disclosure. Therefore, according to the above, some examples of this disclosure are directed to electronic devices such as illustrated in FIGS. 1A-1B. In some examples, FIGS. 1A-1B illustrate block diagrams of example architectures for electronic devices according to some examples of the disclosure. In some examples, electronic device 101 and/or electronic device 160 include one or more electronic devices that comprise a system 100. For example, the electronic device 101 may be a portable device, an auxiliary device in communication with another device, or a wearable device, respectively.

As illustrated in FIG. 1A, the electronic device 101 optionally includes various sensors, such as one or more location sensors 104A, one or more image sensors 106A, one or more touch-sensitive surfaces 109A, one or more motion and/or orientation sensors 110A, one or more eye tracking sensors 112, one or more microphones 113A or other audio sensors, one or more speakers 116A, one or more processors 118A, one or more memories 120A, and/or communication circuitry 122A. One or more communication buses 108A are optionally used for communication between the above-mentioned components of electronic device 101. Additionally, as shown in FIG. 1B, the electronic device 160 optionally includes one or more location sensors 104B, one or more image sensors 106B, one or more touch-sensitive surfaces 109B, one or more orientation sensors 110B, one or more microphones 113B, one or more speakers 116B, one or more processors 118B, one or more memories 120B, and/or communication circuitry 122B. One or more communication buses 108B are optionally used for communication between the above-mentioned components of electronic device 160. The electronic devices 101 and 160 are optionally configured to communicate via a wired or wireless connection (e.g., via communication circuitry 122A, 122B) between the two electronic devices within the system 100. For example, as indicated in FIG. 1A, the electronic device 160 may function as a companion device to the electronic device 101. In some examples, operations described as being performed by system 100 are performed by electronic device 101, companion device 160, another device in the system in communication with electronic device 101 and/or companion device 160, or a combination thereof.

Communication circuitry 122A, 122B optionally includes circuitry for communicating with electronic devices, networks, such as the Internet, intranets, a wired network and/or a wireless network, cellular networks, and wireless local area networks (LANs). Communication circuitry 122A, 122B optionally includes circuitry for communicating using near-field communication (NFC) and/or short-range communication, such as Bluetooth®.

One or more processors 118A, 118B include one or more general processors, one or more graphics processors, and/or one or more digital signal processors. In some examples, memory 120A and/or 120B is a non-transitory computer-readable storage medium (e.g., flash memory, random access memory, or other volatile or non-volatile memory or storage) that stores computer-readable instructions configured to be executed by the one or more processors 118A, 118B to perform the techniques, processes, and/or methods described below. In some examples, memory 120A and/or 120B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, electronic devices 101 and 160 include one or more touch-sensitive surfaces 109A and 109B, respectively, for receiving user inputs, such as tap inputs and swipe inputs or other gestures (e.g., hand-based or finger-based gestures).

Electronic devices 101 and 160 optionally include one or more image sensors 106A and 106B, respectively. The one or more image sensors 106A, 106B optionally include one or more visible light image sensors, such as charged coupled device (CCD) sensors, and/or complementary metal-oxide-semiconductor (CMOS) sensors operable to obtain images of physical objects from the physical environment. The one or more image sensors 106A, 106B also optionally include one or more infrared (IR) sensors, such as a passive or an active IR sensor, for detecting infrared light from the physical environment. For example, an active IR sensor includes an IR emitter for emitting infrared light into the physical environment. The one or more image sensors 106A, 06B also optionally include one or more cameras configured to capture a location and/or a spatial position of physical objects in the physical environment relative to a user of electronic devices 101, 160. The one or more image sensors 106A, 106B also optionally include one or more depth sensors configured to detect the distance of physical objects from electronic devices 101, 160. In some examples, information from one or more depth sensors can allow the device to identify and differentiate objects in the physical environment from other objects in the physical environment. In some examples, one or more depth sensors can allow the device to determine the texture and/or topography of objects in the physical environment.

In some examples, electronic devices 101, 160 uses CCD sensors, event cameras, and depth sensors in combination to detect the physical environment around electronic devices 101, 160. In some examples, the one or more image sensors 106A, 106B include a first image sensor and a second image sensor. The first image sensor and the second image sensor work in tandem and are optionally configured to capture different information of physical objects in the physical environment. In some examples, the first image sensor is a visible light image sensor and the second image sensor is a depth sensor. In some examples, electronic devices 101, 160 uses the one or more image sensors 106A, 106B to detect the position and orientation of electronic devices 101, 160 in the physical environment. For example, electronic devices 101, 160 uses the one or more image sensors 106A, 106B to track the position and orientation of one or more objects of interest relative to the user (e.g., of electronic devices 101, 160) in the physical environment.

In some examples, electronic devices 101 and 160 include one or more microphones 113A and 113B, respectively, or other audio sensors. Electronic devices 101, 160 optionally uses the one or more microphones 113A, 113B to detect sound from the user and/or the physical environment of the user. In some examples, the one or more microphones 113A, 113B include an array of microphones (e.g., a plurality of microphones) that optionally operate in tandem, such as to identify ambient noise or to locate the source of sound in space of the physical environment.

Electronic devices 101 and 160 include one or more location sensors 104A and 104B, respectively, for detecting a location of electronic device 101 and a location of electronic device 160. For example, the one or more location sensors 104A, 104B can include a global positioning system (GPS) receiver that receives data from one or more satellites and allows electronic devices 101, 160 to determine the absolute position of the electronic device in the physical world.

Electronic devices 101 and 160 include one or more orientation sensors 110A and 110B, respectively, for detecting orientation and/or movement of electronic device 101 and orientation and/or movement of electronic device 160. For example, electronic devices 101, 160 uses the one or more orientation sensors 110A, 110B to track changes in the position and/or orientation of electronic devices 101, 160, such as with respect to physical objects in the physical environment. The one or more orientation sensors 110A, 110B optionally include one or more gyroscopes and/or one or more accelerometers.

Electronic devices 101 and 160 are not limited to the components and configuration of FIGS. 1A-1B, but can include fewer, other, or additional components in multiple configurations. In some examples, electronic device 101 and/or electronic device 160 can each be implemented between multiple electronic devices (e.g., as a system). In some such examples, each of (or more of) the electronic devices may include one or more of the same components discussed above, such as various sensors, one or more speakers, one or more processors, one or more memories, and/or communication circuitry. In some examples, electronic devices 101 and/or 160 include a display. This display may be configured such that a person operating the electronic devices 101 and/or 160 may view the display. In some examples, the display is configured such that a person outside a user of the electronic devices 101 and/or 160 may view the display. A person or persons using electronic device 101 and/or electronic device 160, is optionally referred to herein as a user or users of the device.

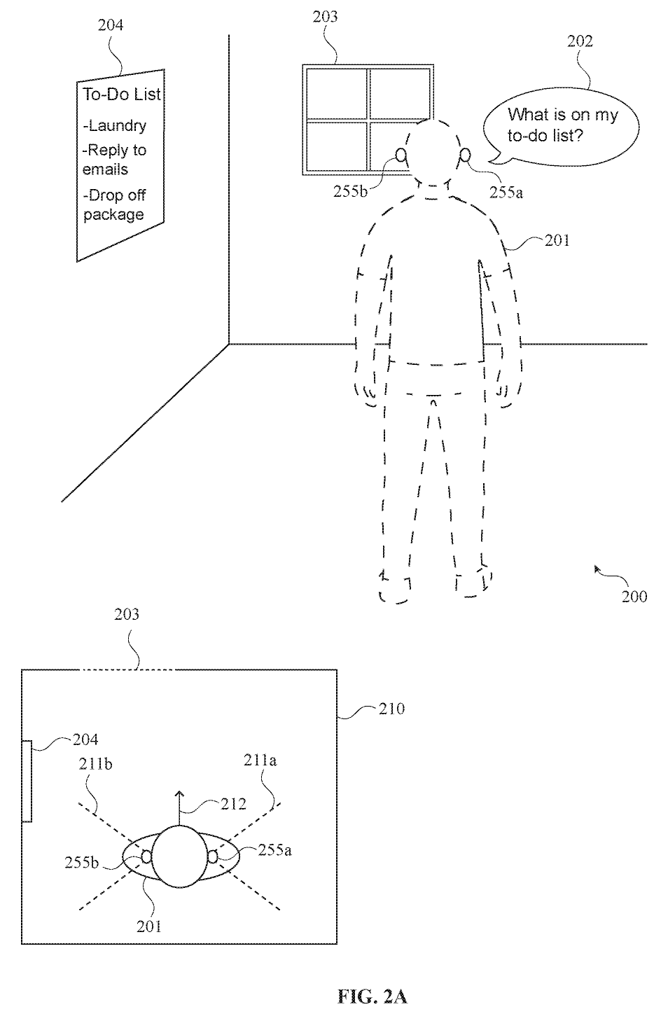

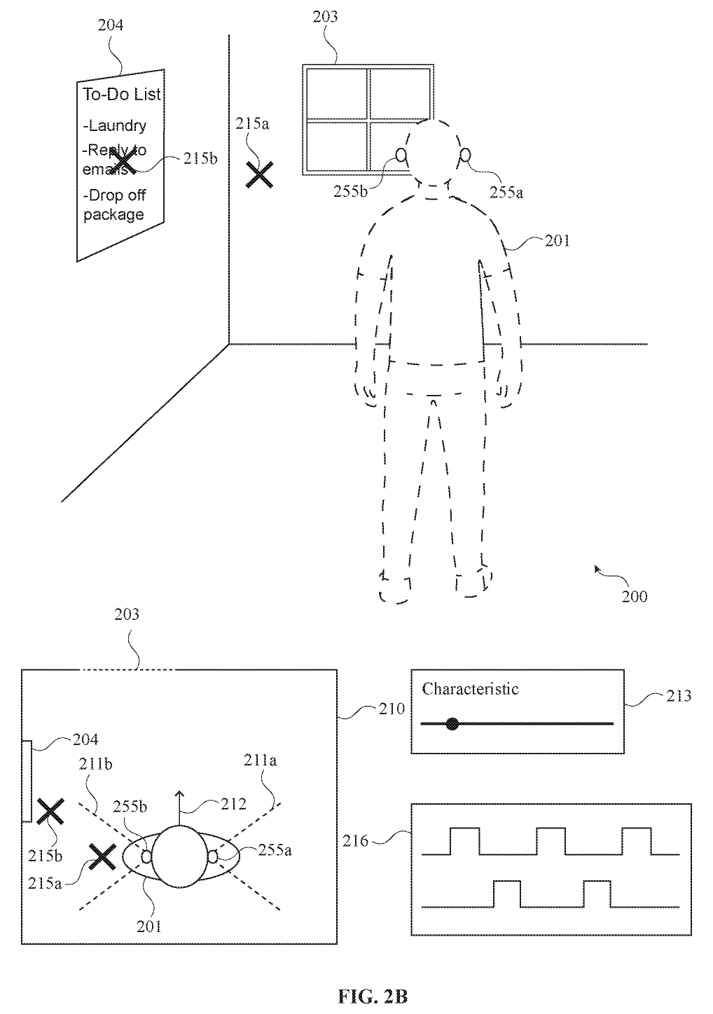

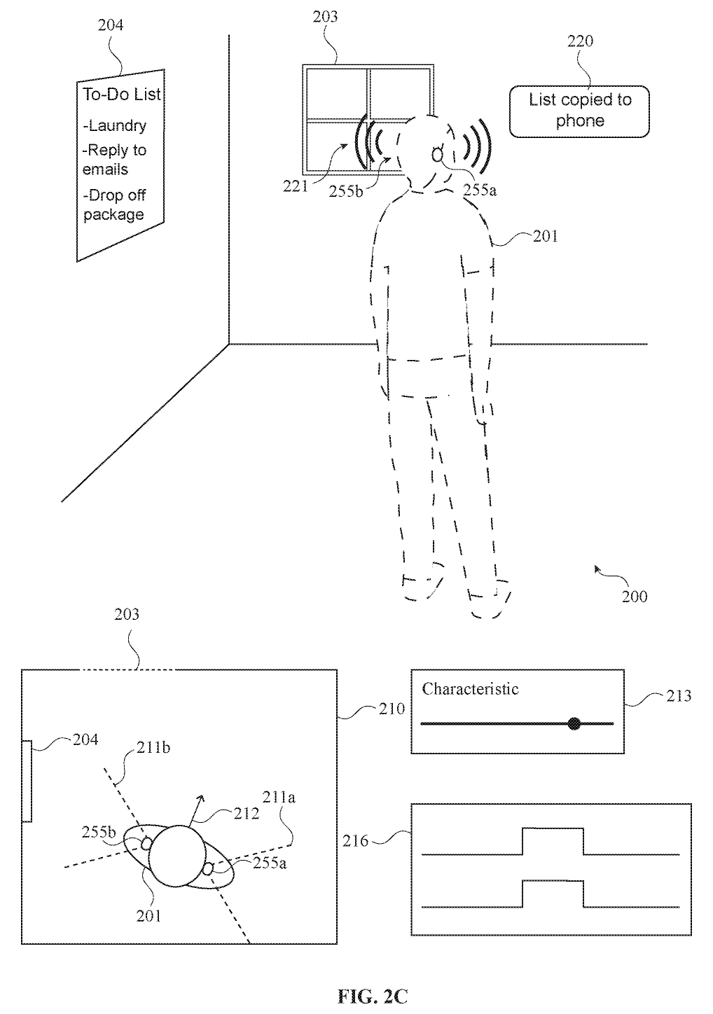

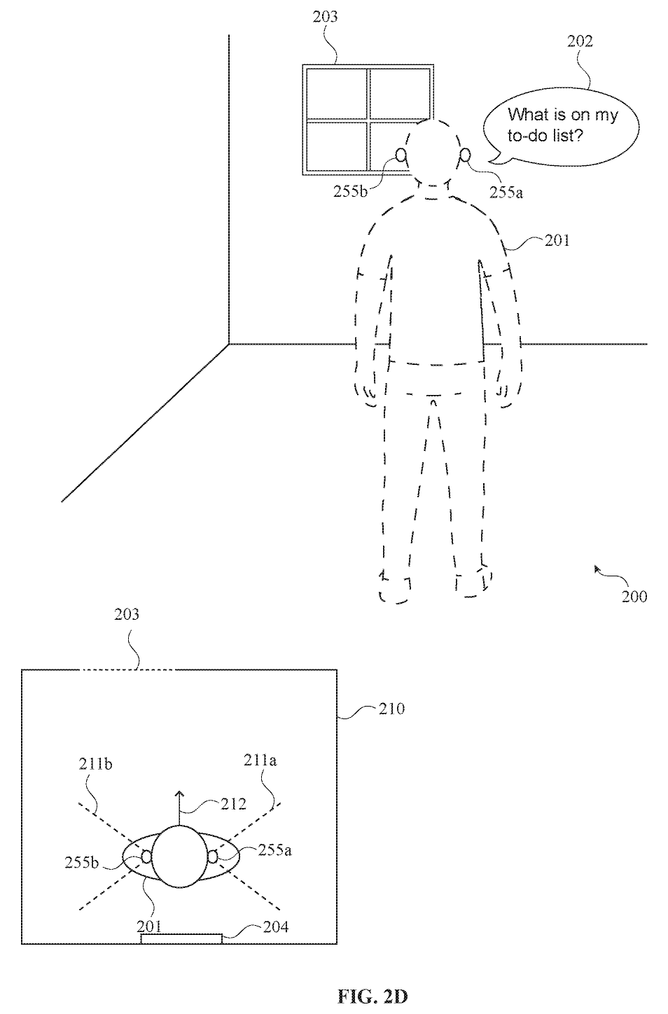

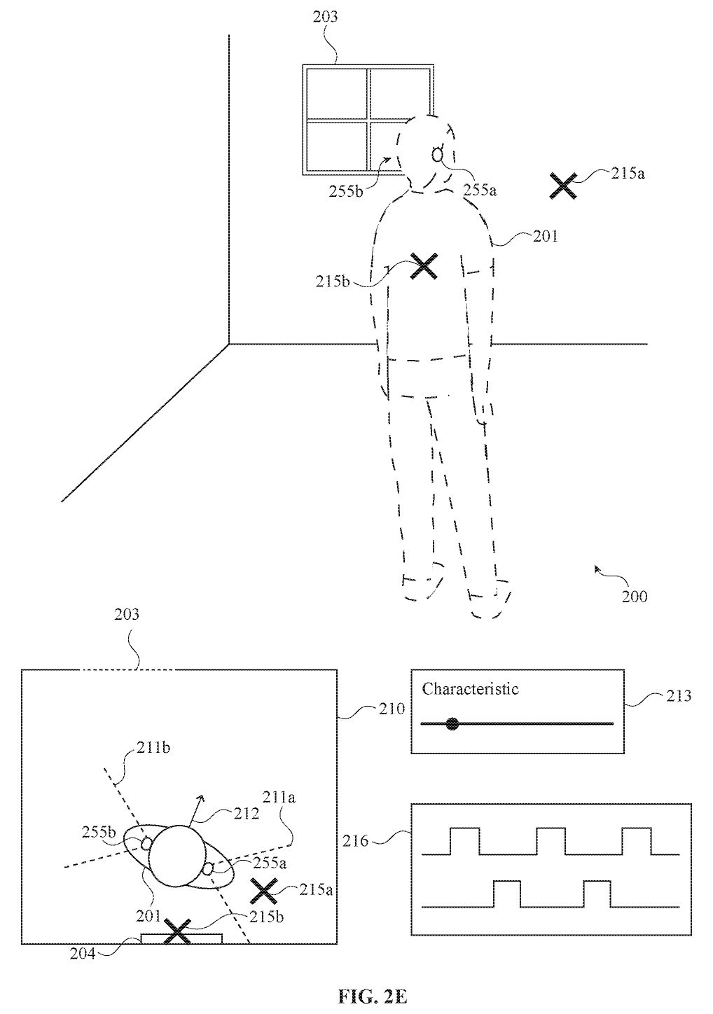

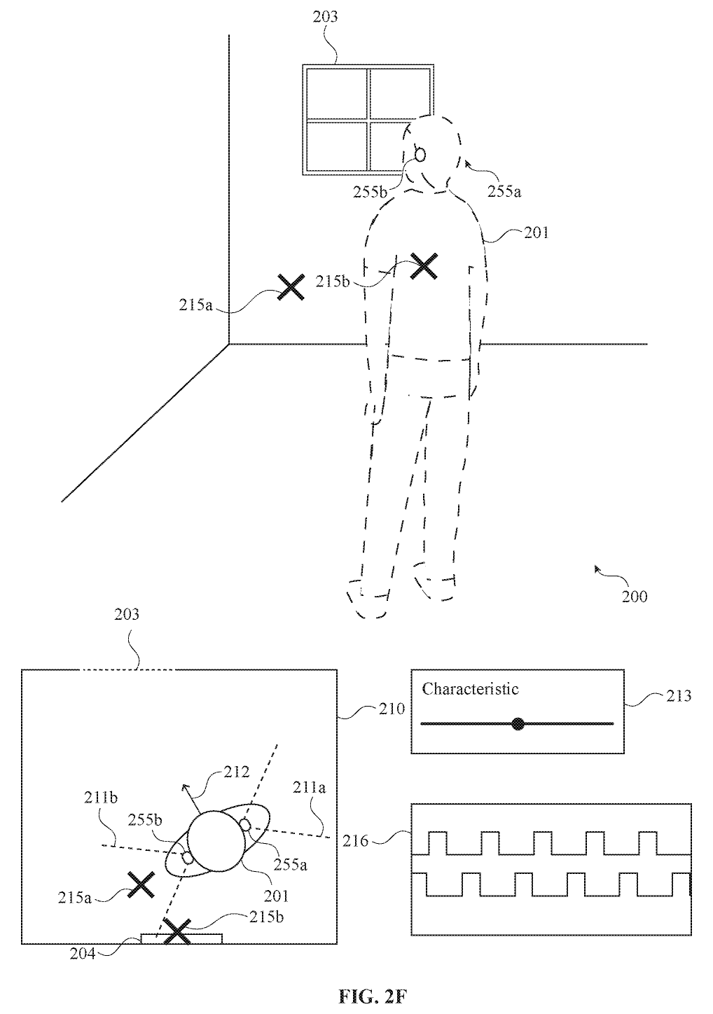

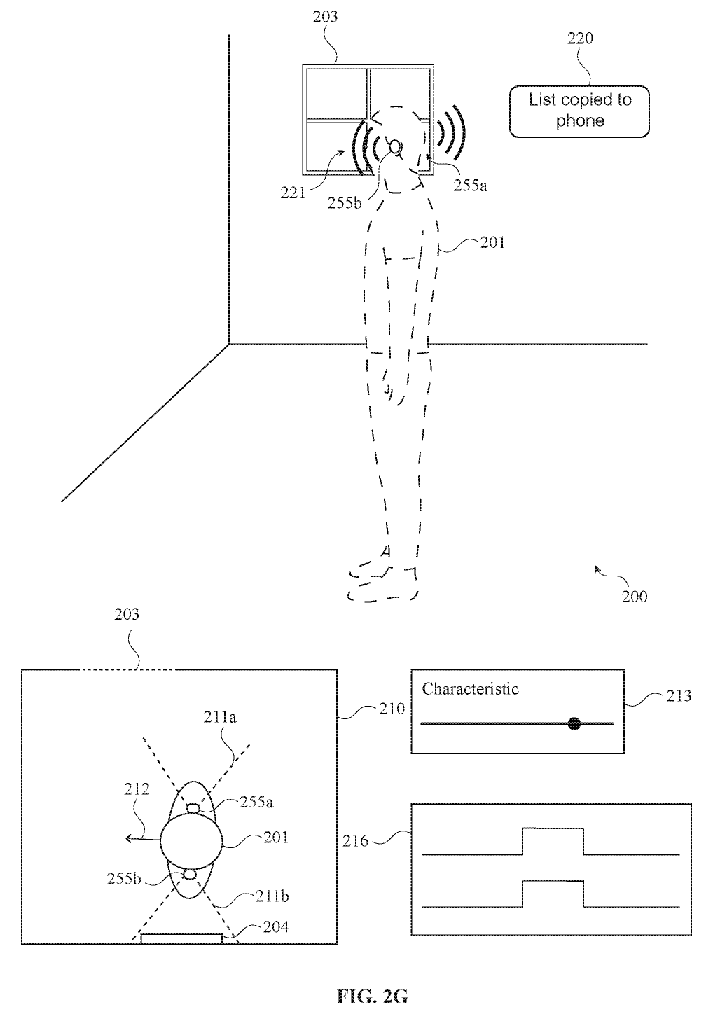

In some examples, electronic devices 101, 160 are optionally included at a wearable device 155 such as illustrated by FIG. 1C. In some examples, the wearable device 155 is or includes a pair of headphones disposed on either side of a user’s head. The wearable device 155 may be designed to fit within or adjacent to a user’s ear, and in some configurations, the wearable device 155 may include support structures to maintain secure placement during movement of the user. In some examples, the wearable device 155 includes a housing, an output device 155A (e.g., optionally corresponding to the one or more speakers 116A and/or 166B), an input device 155B (e.g., optionally corresponding to image sensors 106A), and an audio input device 155C, such as microphones 113A. The housing may include internal electronic components, such as a processor, a power supply, and wireless communication modules, enabling the wearable device 155 to function independently or in conjunction with other devices. For example, the wearable device 155 is optionally in communication with electronic device 160 to perform an action associated with an object in the physical environment such as discussed below in further detail with reference to FIGS. 2A-2G.

In some examples, the wearable device 155 includes one or more cameras, also referred to as the input device 155B, which can be positioned in various locations on the housing. These cameras may be integrated within the structure of the wearable device 155 or attached externally to provide an extended field of view of the physical environment described above with reference to FIGS. 1A-1B. In some examples, the cameras (e.g., input device 155B) are oriented to point outward from the user, to provide a view of the physical environment. In some configurations, these cameras may be positioned at a 90-degree angle relative to the wearable device 155 housing, allowing the cameras to capture images or video from a lateral perspective. In some examples, the cameras (e.g., input device 155B) may be capable of adjusting their orientation dynamically, either mechanically or via digital image processing techniques, to optimize their respective field of views based on user movement or environmental conditions. In some examples, additionally or alternatively, one or more of the cameras (e.g., input device 155B) have a position that is fixed relative to the housing of wearable device 155.

In some examples, input device 155B captures environmental data, such as image data, including detecting objects of interest within a field of view associated with the input device 155B. In some examples, the captured data may be processed locally by the circuitry (e.g., processors 118A) of the wearable device 155, or transmitted to an external computing device for further analysis. For example, the input device 155B optionally captures an image of an object (such as “To-Do List” illustrated below in FIG. 2A) in the physical environment of the wearable device 155 and transmits the captured image and/or a user input detected at the wearable device 155 to a secondary electronic device (e.g., companion device 160). In this example, the wearable device 255 optionally transmits the aforementioned data to the secondary electronic device (e.g., companion device 160) via communication circuitry (e.g., optionally corresponding to communication circuitry 122A), for image processing and determining an action associated with the object to perform. In some examples, the wearable device 155, companion device 160, and/or another electronic device in communication therewith uses image recognition algorithms to identify objects, track motion, or determine spatial relationships between the user of the wearable device 155 and surrounding elements in the physical environment. The system may also employ depth-sensing technologies or multi-camera configurations to enhance object detection accuracy.

In some examples, the system 100 determines an action related to an image of an object within the physical environment in response to detecting a user input and/or a communication received by a secondary electronic device (e.g., companion device 160). The system 100 can interpret various user inputs, including touch inputs, gesture inputs, and voice commands. In some examples, the touch input may be provided via capacitive touch sensors (e.g., touch-sensitive surfaces 109A) and/or physical buttons. In some examples, the gesture inputs can be detected via input device 155B based on user movements, such as a hand gesture or head tilt, while the voice commands may be recognized through the input device 155C using integrated microphones with speech processing capabilities. In some examples, the wearable device 155 may also incorporate multimodal inputs, allowing a combination of inputs to further refine the determination of the action associated with the image of the object in the physical environment. For example, the input device 155C may detect a user input (e.g., a voice input saying “Where is my To-Do List”) and communicate this input alongside the image of the object to the system 100. Upon receiving this input, the system 100 optionally determines the appropriate action related to the image of the object based on the received user input. The system 100 may then communicate with the wearable device 155, which provides one or more prompts to the user, as discussed in further detail below with reference to FIGS. 2A-2G. In some examples, the system 100 processes the user input (e.g., a voice command) using a variety of natural language models to determine one or more actions (e.g., camera-based tasks utilizing AI and/or ML features) requested by the user. For example, the user may optionally request to record a date on a calendar by providing a voice input (e.g., “Add this date to my calendar”). In this example, the system 100 may receive this voice input from the wearable device 155 in tandem with an image of the calendar in the physical environment, determine an action to perform (add date to calendar). Once the secondary electronic device determines the action to perform, the device may additionally process the image of the calendar using a variety of image recognition models (such as a Convolutional Neural Network) to recognize the date to add to the system 100 calendar.

In some examples, the execution of an action by the wearable device 155 occurs independently of whether the input device 155B can actively detect an object of interest within the physical environment in real time. For example, the system 100 detects a user input requesting to interact with a known object (e.g., To Do List illustrated in FIG. 2A), and, in response to the system 100 detecting the user input, the wearable device 155 may execute the action based on stored positional data or prior interactions. This allows for continuous functionality even in cases where the object is temporarily obscured or out of the cameras’ field of view. Additionally, the wearable device 155 may incorporate predictive algorithms to infer object positioning based on prior movement patterns. In some examples, the system 100 receives the user input prior to detecting (e.g., capturing an image of) the object of interest and determines an action associated with the object of interest based on the user input. For example, the user may provide a voice input, such as “Read me my To-Do List,” and the system 100 may determine that the action associated with the object is a relaying audio feedback associated with the object (e.g., “To-Do List”) prior to performing, via input device 155B, a scan of the physical environment for the object of interest. In some examples, the system 100 receives the user input after performing the scan of the physical environment and determines the action associated with the object of interested based on a detection of the object of interest in the recorded scan data. In some examples, the system 100 receives the user input while performing the scan of the physical environment and determines, based on a real-time detection of the object of interest in the scan, the action associated with the object of interest.

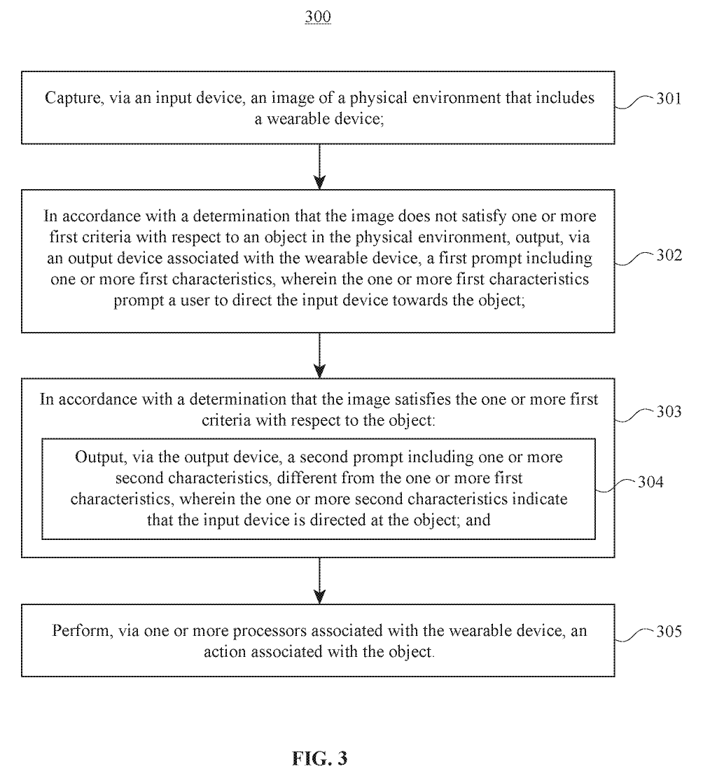

Attention is now directed towards interactions and/or actions with one or more objects that are within a physical environment in proximity with a wearable device (e.g., corresponding to electronic device 101), described with reference to FIGS. 2A-2G. The interactions illustrated in FIGS. 2A-2G are examples of practicing method 300 illustrated in FIG. 3, though other interactions according to method 300 are possible without departing from the scope of the disclosure.

FIGS. 2A-2G illustrate examples of a user 201 within a physical environment 200 wearing a wearable device comprising wearable device 255A and wearable device 255B (e.g., optionally corresponding to wearable device 155). For ease of reference, when describing wearable device 255A and wearable device 255B as a group, the aforementioned devices will be referenced as wearable device 255 herein. For example, wearable device 255 is a set of earbuds, glasses, or headphones having the same structure as wearable device 155. For example, wearable device 255 includes one or more cameras, one or more microphones, and/or one or more speakers as described above with reference to FIGS. 1A-1C. In some examples, the physical environment 200 includes a window 203 and an object 204 (e.g., illustrated as “To-Do List,” optionally referred to as an “object of interest”) within a field of view of the user 201. In some examples, such as illustrated in the top-down view 210, the wearable device 244 includes a field of view 211B and field of view 211A associated with the input device(s) (e.g., one or more cameras) of wearable device 255B and the wearable device 255A that detect the object 204 as discussed in further detail below.

FIG. 2A illustrates the wearable device 255 detecting a user input 202 (e.g., illustrated as “What is on my to-do list”) related to an object 204 in the physical environment 200 of the wearable device 255. In some examples, the wearable device 255 provides a prompt to guide the user to direct the wearable device 255 towards the object 204 and/or performs an action associated with the object 204 as described in further details below with reference to FIGS. 2B-2C. In some examples, such as illustrated by FIG. 2A, the physical environment 200 includes the object 204 on a wall to the left of the viewpoint of the user 201, and the window 203 in front of the user 201. By prompting the user 201 to align the wearable device 255 with the object 204, the system improves the likelihood that an input device associated with the wearable device 255 captures the object 204 from an optimal perspective, enhancing detection accuracy and ensuring reliable execution of the associated action.

In some examples, such as illustrated in FIG. 2A, the wearable device 255 detects the user input 202 via wearable device 255A and/or wearable device 255B. Wearable device(s) 255A and/or 255B optionally include one or more integrated microphones such as described above with reference to input device 155C. In some examples, the user input 202 corresponds to a verbal output, such as illustrated by FIG. 2A, produced by the user 201. This verbal output can correspond to a variety of user inputs such as, but not limited to, as is illustrated in FIG. 2A. In some examples, the wearable device 255A and/or the wearable device 255B detect the user input 202 and process the user input 202 via system 100 as described above with reference to FIGS. 1A-1B. Detecting user input 202 through multiple microphones allows the wearable device 255 to accurately capture verbal commands even in noisy environments, improving input reliability and reducing the chance of misinterpretation.

In some examples, the one or more cameras of the wearable device 255 capture one or more images of the physical environment 200. In some examples, wearable device 255A and input wearable 255B continuously capture image data within respective fields of view of the physical environment 200. For example, such as illustrated in the top-down view 210 of FIG. 2A, the wearable device 255B includes a field of view 211B to the left of user 201, and the wearable device 255A includes a field of view 211A to the right of the user 201. In some examples, the aforementioned fields of view represent portions of the physical environment 200 that the respective input devices of wearable devices 255A and 255B are able to detect an object of interest (e.g., object 204). In some examples, field of views 211A and 211B have respective fields of view that capture a range of the physical environment 200 (e.g., 360 degrees, 180 degrees, 90 degrees). The aforementioned range may, such as illustrated in FIG. 2A, encompass a portion of the physical environment 200 centered around the user 201. By capturing a broad field of view around the user 201, the wearable device 255 increases the probability that objects (e.g., object 204) of interest are detected without requiring the user 201 to manually scan the physical environment 200, improving detection efficiency and spatial coverage.

In some examples, such as illustrated by the top-down view 210 of FIG. 2A, the field of view 211B associated with the wearable device 255B captures a portion of the object 204. This capture optionally occurs prior to, during, or after the system 100 (e.g., wearable device 255, electronic device 101, and/or companion device 160) detects the user input 202, as described above. In some examples, the wearable device 225 processes the portion of the object 204 captured by the wearable device(s) 255A and 255B and, in response to capturing the portion of the object 204, the wearable device 225 prompts the user 201 to perform one or more actions as discussed in further detail below. Prompting the user 201 only after optimal portions of the object 204 have been captured reduces errors in action execution and ensures that any actions performed by the wearable device 255 are based on accurate and complete data from the physical environment 200.

FIG. 2B illustrates an example of the wearable device 255 providing the user 201 one or more prompts in response to capturing a portion of the object 204 with wearable device(s) 255A and/or 255B as illustrated above by FIG. 2A. In some examples, such as illustrated in FIG. 2B, the wearable device 255 provides an auditory prompt, such as a clicking sound, to guide the user 201 to direct one of the wearable devices 255A or 255B towards the location of the object 204. In some examples, the wearable device 255 presents the auditory prompt via an output device, such as output device 155A (e.g., one or more speakers) discussed above with reference to FIG. 1C. In some examples, the wearable device 255 presents the auditory prompt in such a manner that the auditory prompt appears to be emitted from a predetermined spatial location within the physical environment 200 to provide directional guidance, as discussed herein, to the user 201. For example, such as illustrated in FIG. 2B, a portion of the auditory prompt (e.g., optionally referenced as prompt 215B) may sound like it originates from the location of the object 204. The auditory prompt may be dynamically adjusted based on the user’s position, utilizing binaural audio processing to create the perception of a three-dimensional sound source. In some examples, the auditory prompt may vary in intensity or frequency modulation to indicate proximity of the wearable device 255 to a target position, as discussed in further detail below. In some examples, multiple auditory prompts may be coordinated within the physical environment 200.

In some examples, such as illustrated in FIG. 2B, the auditory prompt includes a two-part prompt, with one portion of the prompt (e.g., prompt 215B) being simulated as originating from the location of the object 204, and a second portion of the prompt (e.g., prompt 215A) being simulated as originating proximate to the user 201 within the field of view 211B of wearable device 255B. Thus, in FIG. 2B, the auditory prompt directs the user to turn so that the field of view 211B of wearable device 255B (e.g., the simulated location of prompt 215A) moves towards the object 204 (e.g., the simulated location of prompt 215B). In some examples, the wearable device 255 presents prompts 215A and 215B in an alternating, cyclical fashion, providing the user with the ability to distinctly parse prompts 215A and 215B, such as illustrated by alternation period 216.

In some examples, such as illustrated by alternation period 216, the alternating “clicks” (e.g., prompt 215A and prompt 215B) may originate from wearable device 255A and/or wearable device 255B. The alternation period of the “clicks” (e.g., prompts 215A and 215B) may be dynamically adjusted based on the difference in position between object 204 and the field of view 211B of wearable device 255B. For example, as the user 201 directs the field of view 211B of wearable device 255B towards object 204, the wearable device 255 optionally changes the alternation period of the “clicks” in a first direction (e.g., decreases or increases) as a cue to the user 201 that the wearable device 255B is being moved in the correct direction. In some examples, if the user 201 were to move the wearable device 255B in the opposite direction (e.g., moving the field of view 211B away from the object 204), the wearable device 255 would change the alteration period of the “clicks” in a second direction as a cue to the user 201 that the wearable device 255B is being moved in the incorrect direction.

Additionally or alternatively, in some examples, the intensity of each “click” may be modified in response to the proximity of the field of view 211B to the object 204, wherein the “clicks” may change in loudness and/or sharpness in a first direction (e.g., by increasing or decreasing) as the user 201 positions the field of view 211B of wearable device 255B towards the object. If the user 201 were to move the field of view 211B away from the object 204, the wearable device 255 would modify the intensity, such as loudness and/or sharpness, of each “click” in a second direction.

In some examples, the “clicks” (e.g., prompts 215A and 215B) have a first alternation period and first intensity, such as illustrated by alternation period 216 and characteristic 214 in FIG. 2B. This first alternation period and first amount of intensity optionally are dependent on the orientation of the field of view 211B relative to the object in the physical environment 200. In some examples, such as discussed above, prompt 215A and prompt 215B provide an auditory prompt to the user 201 to direct wearable device 255B towards the object 204, as discussed in further detail below.

In the example of FIG. 2B, the field of view 211A of wearable device 255B is closer to the object 204, based on the wearable device 255B capturing a portion of the object 204 using a camera. Thus, in this example, the wearable device 255 outputs prompts 215A and 215B to direct the user 201 to move (e.g., rotate) in order to reposition the field of view 211B of wearable device 255B towards object 204. In some examples, the wearable device 255 alternatively determines that wearable device 255A should be used to capture an image of object 204. For example, wearable device 255A captures a portion of the object 204 in field of view 211A or the field of view 211B of wearable device 255B is at least partially obstructed as described herein. In some examples, if the wearable device 255 determined that wearable device 255A should be used to capture an image of the object 204, then the wearable device 255 would output prompts that direct the user to move (e.g., rotate) to position the field of view 211A of wearable device 255A towards the object 204. For example, instead of outputting prompt 215B with an audio spatial location corresponding to a physical location within the field of view 211B, the wearable device 255 would output a prompt (e.g., “clicks,” optionally referred to as an “audio cue”) with an audio spatial location corresponding to a physical location of field of view 211A. Outputting a prompt that sounds like it is emanating from a location within the field of view 211A optionally has one or more characteristics of prompt 215B, such as the wearable device 255 playing the prompt that sounds like it is emanating from a location of field of view 211A in alternation with prompt 215B with one or more of the characteristics described above. In some examples, the audio spatial location simulated by prompts 215A and 215B have a predetermined spatial orientation relative to the user 201.

FIG. 2C illustrates the user 201 in the physical environment 200 directing wearable device 255B towards the object 204, and in response, the system 100 performs action 220. For example, action 220 includes recognizing the text included in object 204 and storing the text of object 204 at an electronic device (e.g., companion device 160) included in system 100. In some examples, the system 100 is configured to perform one or more actions 220 associated with the object 204 in response to detecting a user input (e.g., user input 202). In some examples, the user 201 rotates their head (as compared to illustrated in FIG. 2B), directing the field of view 211B of wearable device 255B towards the object 204 in response to prompts 215A and 215B discussed above. In some examples, as the user 201 directs wearable device 255B and its associated camera more toward the object 204, the spacing period between the “clicks” generated by wearable device 255B progressively changes (e.g., decreases), providing an auditory indication of improved alignment of the wearable device 255B with the object 204. This change in the spacing period between “clicks” may serve as real-time feedback, allowing the user 201 to make adjustments to the orientation of the wearable device 255. In some examples, the spacing period between “clicks,” as illustrated by alternation period 216 in FIG. 2B and below in FIG. 2E, enables the user 201 to determine when a respective input device (e.g., wearable devices 255B, 255A) are sufficiently aligned with the object 204.

In some examples, and as shown in FIG. 2C, wearable device 255B detects that the object 204 is within the field of view 211B of wearable device 255B, and in response, captures an image of the object 204 to perform the one or more actions 220. For example, such as illustrated in FIG. 2C, the wearable device 255 optionally performs the one or more actions 220 (e.g., “List copied to phone”) associated with the object 204 in response to the wearable device 255 being directed towards (and capturing an image) the object 204. It should be noted that this action as illustrated by FIG. 2C is non-limiting, as the wearable device 255 is configured to perform a wide variety of actions such as, but not limited to, adding a date associated with a detected calendar, playing a song associated with a detected movie poster, opening an application/website associated with a detected Quick Response (QR) code, for example. In some examples, the one or more actions 220 as previously described utilize one or more AI and/or ML features to perform the aforementioned tasks. In some examples, the one or more actions 220 may be performed at the system 100. In some examples, the one or more actions 220 may be performed at the wearable device 255. In some examples, the one or more actions 220 are performed at a secondary device (e.g., companion device 160) in response to receiving the captured image of object 204 and/or information associated with the captured image of object 204 processed by wearable device 255 and the user input 202.

In some examples, such as illustrated by FIG. 2C, in response to capturing an image of object 204 that enables the system 100 to perform the action with object 204, the wearable device 255 provides a second prompt 221, different than prompts 215A and 215B. This second prompt 221 may be an auditory prompt provided by wearable device 255, distinct from (e.g., illustrated by characteristic 213) prompts 215A and 215B. In some examples, the second prompt 221 possesses one or more characteristics distinct from prompts 215A and 215B. For example, prompts 215A and 215B may correlate to “clicks” or “beeps” audible to the user 201, while the second prompt 221 may correlate to a “ding” or a “shutter” sound similar to a typical audio sound made by a phone unlocking. Thus, one or more of an intensity, timbre, tone, duration, and/or other quality of second prompt 221 differs from one or more of an intensity, timbre, tone, duration, and/or other quality of prompts 215A and 215B. In some examples, the second prompt 221 is provided at wearable device 255A and/or wearable device 255B in response to a successful image capture of the object 204 and/or the one or more actions 220 being performed with respect to object 204. In some examples, the second prompt 221 may be a “click” similar to prompts 215A and 215B. In some examples, the second prompt 221 is a sound effect, vocal prompt, music, or any variety of non-verbal sounds. These variety of auditory prompts may be optionally predetermined by user 201, based on a user preference.

In the example illustrated in FIGS. 2A-2C, the wearable device 255 was able to capture a portion of object 204 at the time the user input 202 was received. In some examples, the wearable device 255 fails to capture a portion of the object 204 in the physical environment 200 due to a user’s (e.g., user 201) spatial position and/or orientation when the system 100 receives an input requesting performance of an action with respect to a real object in the physical environment 200 of the wearable device 255. In these instances, the wearable device 255 optionally provides the prompts 215A and 215B in a fashion that prompts the user 201 to alter the orientation of the wearable device 255 to “scan” the physical environment 200, such as is illustrated in FIG. 2D.

FIG. 2D illustrates the user 201 providing the above-described user input 202 in the physical environment 200 where the object 204 is outside the respective fields of view 211A and 211B of wearable devices 255A and 255B. In some examples, wearable device 255 detects the user input 202 (e.g., “What is on my to-do list?”). In response to detecting the user input 202, wearable devices 255A and 255B capture one or more images of the physical environment 200 and, based on the images captured, determine that the objection 205 is not within the total fields of view of wearable devices 255A and 255B (e.g., fields of view 211A and 211B). In some examples, upon determining that the object 204 is not readily detectable within the total field of (e.g., 180 degrees on either side of the user 201), the wearable device 255 infers that the object 205 is likely positioned in a location in the physical environment 200 outside the total field of view. For example, as illustrated in FIG. 2D, the respective fields of view 211A and 211B may cover a total field of view to the right and to the left of the user 201, but not in front or behind the user 201.

In this instance, the wearable device 255 may infer that the object 204 is at a location in the physical environment 200 in front of or behind the user 201. In accordance with this inference, the wearable device provides prompts 215A and 215B to direct the user 201 to engage in a full “scan” of the physical environment 200 to locate the object 204 in the inferred location as discussed in further detail below with reference to FIG. 2E. In some examples, the prompts 215A and 215B provided during the full “scan” of the physical environment 200 are provided in such a manner that the user 201 directs the wearable device 255 around the physical environment 200 in a predefined motion (e.g., optionally predetermined by the system 100 prior to wearable device 255 providing prompts 215A and 215B). In some examples, the prompts 215A and 215B provided during the full “scan” of the physical environment include one or more characteristics different than the one or more characteristics of the provided prompts 215A and 215B illustrated by FIGS. 2B and 2E.

In some examples, the wearable device 255 determines that the object 204 may be within the respective fields of view 211A and 211B but obstructed from the aforementioned field of views. With this determination, the wearable device 255 may select wearable device 255A or 255B to perform the “scan” of the physical environment 200 based on a determination of a “least obstructed” of the wearable devices 255A and 255B. For example, the wearable device 255 may detect (based on the captured image) that wearable device 255A is obstructed by hair of user 201 (not pictured). Additionally or alternatively, for example, wearable device 255A and/or 255B can be obstructed by clothing (e.g., a hat) of the user and/or improper positioning of wearable device 255A and/or 255B. In accordance with a determination that wearable device 255A is obstructed, the wearable device 255 outputs prompts that instruct the user to scan the physical environment 200 with wearable device 255B. For example, the wearable device 255 outputs a prompt including a portion of the prompt that sounds like it is located in the field of view 211B of wearable device 255B. In accordance with a determination that wearable device 255B is obstructed, the wearable device 255 outputs prompts that instruct the user to scan the physical environment 200 with wearable device 255A. For example, the wearable device 255 outputs a prompt including a portion of the prompt that sounds like it is located in the field of view 211A of wearable device 255A.

FIG. 2E illustrates an example of the user 201 moving the wearable device 255 in response to prompts 215A and 215B according to some examples of this disclosure. In some examples, such as illustrated by FIG. 2E, the user 201 rotates the wearable device 255 to the right in the physical environment 200 relative to the position shown in FIG. 2D in response to prompt 215A having a spatial audio location to the right of the user 201 in the physical environment 200. In other words, wearable device 255 plays prompt 215A so that prompt 215A sounds like it is located to the right of the user 201, for example.

In response to the user 201 directing the wearable device 255 towards a right-side portion of the physical environment 200 relative to the user 201, such as illustrated in FIG. 2E, the wearable device 255 optionally generates the prompts 215A and 215B, instructing the user 201 to perform a broader search of the physical environment 200 to locate the object 204. In some examples, such as illustrated in FIG. 2E, the wearable device 255 provides prompt 215A at an audio spatial location to the right of user 201 and provides prompt 215B at an audio spatial location behind the user 201. These audio spatial locations are optionally determined by the wearable device 255, in response to failing to capture the object 204 within the respective fields of view 211A and 211B of the wearable devices 255A and 255B, respectively.

As part of process to locate object 204 within the physical environment 200, the wearable device 255 instructs the user 201 to turn to systematically scan the physical environment 200 and evaluates whether the field of view 211A of wearable device 255A or the field of view 211B of the wearable device 255B has captured an image of a portion of the object 204. In some examples, such as illustrated in FIG. 2E, the user 201 rotates to the right, thereby directing the wearable device 255 to the right, capturing, via the wearable devices 255A and 255B, previously undetected portions of the physical environment 200. In some examples, if the object 204 is not detected after the user rotates as shown in FIG. 2E, the wearable device 255 updates the prompt(s) 215A and/or 215B as discussed in further detail below with reference to FIG. 2F. In some examples, the fields of view 211A and 211B fail to capture the object 204 due to an obstruction in the physical environment 200 and/or an obstruction provided by the user 201 (e.g., improper placement of wearable device 255, wearable devices 255A and 255B, an object in the physical environment 200 not of interest to the user 201, etc.). In this instance, the wearable device 255 optionally determines an input device with the least amount of obstruction as discussed in further detail herein.

FIG. 2F illustrates an example of the wearable device 255 outputting a prompt directing the user 201 to reposition wearable device 255 (e.g., by rotating) in a manner different from the manner illustrated in FIG. 2E. In some examples, upon determining that the object 204 is still not within the fields of view 211A and 211B in response to the user 201 directing the wearable device 255 to the right as guided by prompts 215A and 215B in FIG. 2E, the wearable device 255 generates prompts 215A and 215B to guide the user’s movement, as shown in FIG. 2F. In some examples, this prompt is emitted from the wearable device 255 with an updated (e.g., increased or decreased) volume, as indicated by characteristic 213 in FIG. 2F, and spacing period between “clicks,” as indicated by alternation period 216 in FIG. 2F, compared to characteristic 213 and alternation period 216 in FIG. 2E. Additionally or alternatively, the wearable device 255 outputs prompt 215A in the field of view 211B of wearable device 255B in FIG. 2F, signaling the user 201 to turn to the left. As the user 201 begins to rotate to the left as illustrated by FIG. 2F, the wearable device 255 optionally continuously adjusts the auditory feedback (e.g., prompt 215A and/or prompt 215B), as described above, reinforcing the directional cue until the object 204 enters the respective field of views (e.g., field of view 211A and/or field of view 211B) of an input device of wearable device 255A or wearable device 255B. In some examples, such as illustrated by FIG. 2F, wearable device 255B detects a portion of object 204 within field of view 211B, and in response, wearable device 255 provides the second prompt 221, as discussed in further detail below with reference to FIG. 2G. In some examples, the wearable device 255 updates the characteristic 213 of the prompts 215A and 215B in FIG. 2G as the object 204 enters a respective field of view (e.g., field of view 211B) of the wearable device 255. For example, wearable device 255 increases characteristic 213 (e.g., increase in volume, increase in pitch, etc.), and increases the alternation of “clicks” as shown by alternation period 216 as the object 204 enters the field of view 211B of wearable device 255B in FIG. 2F, compared to the characteristic 213 and alternation period 216 in FIG. 2E while the object 204 was not captured by field of view 211A or field of view 211B.

While prompts 215A and 215B provide guidance to the user 201 as to a proper direction/orientation of the wearable device 255 with respect to the object 204, the user 201 may erroneously direct the wearable device 255 in a direction not corresponding to the audio spatial location of prompt 215A or prompt 215B associated with a location of the object 204. In such cases, the wearable device 255 may detect, via wearable device 255A and/or wearable device 255B the improper direction of wearable device 255 and modify characteristic 213 and/or alternation period 216. For example, the user 201 may direct the wearable device 255 to the right in the physical environment 200 while the object 204 is to the left of the user 201 in the physical environment 200. In response, the wearable device may increase characteristic 213 (e.g., increase the volume of the “clicks”), and/or increase the alternation period 216 (e.g., increasing the time between respective “clicks”), as discussed above.

In response to the object entering a respective field of view of an input device (e.g., wearable devices 255A and 255B), as illustrated by FIG. 2G, wearable device 255 provides the second prompt 221 as a signal to the user 201 that the object 204 has been captured. In some examples, the second prompt 221 is provided as the wearable device 255 performs the one or more actions 220. In some examples, the one or more actions 220 include one or more characteristics of the one or more actions 220 as discussed above with reference to FIG. 2C. In some examples, such as illustrated by FIG. 2G, the second prompt 221 is provided by wearable device 255 as a pair of synchronized “clicks” at wearable devices 255A and 255B, illustrated by alternation period 216.

FIG. 3 is a flow diagram illustrating a method 300 of directing an input device at an object in a physical environment and performing an action associated with the object according to some examples of this disclosure. The method is optionally performed at one or more devices described above with reference to FIGS. 1-2G (e.g., wearable device 155, companion device 160, electronic device 101). Some operations in method 300 are, optionally, combined, repeated, and/or skipped and/or the order of some operations is, optionally, changed without departing from the scope of the disclosure. In some examples, the system 100 includes non-transitory computer readable media as described herein storing instructions for executing one or more steps of method 300.

In some examples, block 301, in accordance with the method 300, involves capturing an image of a physical environment around a user (e.g., user 201) using a wearable device according to some examples of this disclosure. In some examples, the wearable device corresponds to the wearable device 255 with reference to FIGS. 2A-2G as discussed above. In some examples, the wearable device captures an image of an object in the physical environment via one or more cameras, such as disclosed by the input device 155B or the input devices discussed above with reference to wearable devices 255A and 255B. In some examples, a single input device captures the image of the object (e.g., object 204). For example, the wearable device may be a pair of headphones (e.g., wearable devices 255A and 255B discussed above) that include one or more cameras at one or more of the headphones. In this scenario, the object may be to the right of the user in the physical environment (e.g., optionally corresponding to physical environment 200) and subsequently captured by the one or more cameras of the right headphone (e.g., optionally corresponding to wearable device 255A). In some examples, the image of the physical environment captured by the wearable device includes a portion of the total environment corresponding to the field of view of the wearable device as discussed above with reference to FIG. 2A. In some examples, the image of the environment corresponds to one or more images continuously captured by the wearable device (e.g., a video) such discussed above with reference to the wearable device 155 of FIG. 1C.

In some examples, block 302, in accordance with the method 300, involves determining that the image of the physical environment as discussed above with reference to block 301 does not satisfy one or more first criteria associated with the object in the physical environment and outputting a first prompt including one or more first characteristics to prompt a user to direct the input device towards the object according to some examples of this disclosure. In some examples, the object corresponds to the object discussed above with reference to block 301 and/or the object 204 discussed above with reference to FIGS. 2A-2G. In some examples, the wearable device determines that the image of the physical environment does not satisfy the one or more first criteria based on a detection that the image includes a portion of the object insufficient to perform a respective action with respect to the object such as illustrated by the field of view 211B in FIG. 2F. For example, a camera of the wearable device (e.g., input device 155B) may capture a portion of the physical environment that includes a portion of the object. Using various image detection software, such as a RetinaNet model, the wearable device may detect that the object is present in the image of the physical environment and does not satisfy the one or more first criteria. In some examples, such as previously discussed, the image of the environment includes a first portion of the object without including a second portion of the object, necessitating the wearable device to be directed more accurately at the object (optionally to satisfy the one or more first criteria). In accordance with a determination that the image does not satisfy the one or more first criteria, the wearable device optionally outputs the first prompt including one or more first characteristics. In some examples, the first prompt corresponds to an audio prompt detectable by the user as discussed above with reference to FIG. 2C. In some examples, the one or more first characteristics of the first prompt correspond to “clicks” that possess an audio spatial location as discussed above with reference to FIG. 2C.

In some examples, block 303, in accordance with the method 300, involves determining that the image discussed above with reference to block 301 and block 302 satisfies the one or more first criteria with respect to an object in the physical environment according to some examples of this disclosure. In some examples, the wearable device (e.g., wearable device 255) receives the image of the physical environment in a similar manner as discussed above with reference to block 301 (e.g., via input device 155B). In some examples, the one or more first criteria are satisfied by a determination by computer circuitry of the wearable device that the image contains a portion object sufficient to perform a respective action with respect to the object (e.g., the entire object). In accordance with a determination that the image satisfies the one or more first criteria with respect to the object, the wearable device optionally produces a second prompt as discussed in further detail below with reference to block 304.

In some examples, block 304, in accordance with the method 300, involves outputting a second prompt that includes one or more second characteristics to indicate to the user that the wearable device is directed at the object in the physical environment according to some examples of this disclosure. In some examples, the wearable device produces the second prompt via an output device, such as output device 155A (e.g., optionally corresponding to the one or more speakers 116A/166B) as discussed above with reference to FIG. 1C. For example, the user may direct the wearable device towards the object (e.g., object 204) in response to the first prompt described above with reference to block 302 and produce the second prompt once an input device of the wearable device (e.g., input device 155B) detects that the object is within its respective field of view). In some examples, the one or more characteristics of the second prompt correspond to a “bell” sound, indicating to the user that the wearable device is directed towards the object in the physical environment.

In some examples, block 305, in accordance with the method 300, involves performing an action associated with the object according to some examples of this disclosure. In some examples, the wearable device performs the action associated with the object. For example, an output device of the wearable device (e.g., output device 155A) may read aloud a text associated with the object, such as a “To-Do List” as discussed above with reference to FIGS. 2A-2G. In some examples, the action associated with the object is performed simultaneously with the wearable device producing the second prompt discussed above with reference to block 304. In some examples, the wearable device transmits a command to a connected secondary electronic device to perform the action associated with the object.

It should be understood that the particular order in which the blocks of the flowchart of FIG. 3 have been described is merely exemplary and is not intended to indicate that the described order is the only order in which the operations could be performed. One of ordinary skill in the art would recognize various ways to reorder the operations described herein.

Therefore, according to the above, some examples of the disclosure are directed to a wearable device comprising: an input device, an output device configured to provide one or more prompts to a user, one or more processors, memory, and one or more programs, wherein the one or more programs are stored in the memory and configured to be executed by the one or more processors, the one or more programs including instructions for capturing, via the input device, an image of a physical environment that includes the wearable device. Additionally or alternatively to one of more of the examples disclosed above, in some examples, in accordance with a determination that the image does not satisfy one or more first criteria with respect to an object in the physical environment, outputting, via the output device, a first prompt including one or more first characteristics wherein the one or more first characteristics prompt a user to direct the input device towards the object. Additionally or alternatively to one of more of the examples disclosed above, in some examples, in accordance with a determination that the image satisfies the one or more first criteria with respect to the object: outputting, via the output device, a second prompt including one or more second characteristics different from the one or more first characteristics, wherein the one or more second characteristics indicate that the input device is directed at the object, and performing, via the one or more processors, an action associated with the object. Additionally or alternatively to one of more of the examples disclosed above, in some examples, the input device further comprises a first electronic device configured to be worn on a first side of a user, and a second electronic device, different than the first electronic device, configured to be worn on a second side of a user, different than the first side of a user. Additionally or alternatively to one of more of the examples disclosed above, in some examples, capturing the image of the physical environment that includes the wearable device includes capturing a first image, via an input device of the first electronic device, and capturing a second image, different than the first image, via an input device of the second electronic device, different than the input device of the first electronic device. Additionally or alternatively to one of more of the examples disclosed above, in some examples, in accordance with a determination that the first image does not satisfy one or more respective criteria with respect to the object in the physical environment, the one or more first characteristics of the first prompt cue the user to rotate the input device in a first direction. Additionally or alternatively to one of more of the examples disclosed above, in some examples, in accordance with a determination that the second image does not satisfy the one or more respective criteria with respect to the object in the physical environment, the one or more first characteristics of the first prompt cue the user to rotate the input device in a second direction, different than the first direction. Additionally or alternatively to one of more of the examples disclosed above, in some examples, the first image satisfies a first criterion of the one or more respective criteria when a view of the physical environment included in the first image is less obstructed than a view of the physical environment included in the second image, and the second image satisfies the first criterion of the one or more respective criteria when the view of the physical environment included in the second image is less obstructed than the view of the physical environment included in the first image. Additionally or alternatively to one of more of the examples disclosed above, in some examples, the one or more programs further include instructions for detecting movement of the input device relative to the object, and in response to detecting the movement of the input device relative to the object, capturing, via the input device, a second image of the physical environment, different than the image of the physical environment, and outputting, via the output device, the first prompt including one or more third characteristics different from the one or more first characteristics in accordance with the movement of the input device relative to the object. Additionally or alternatively to one of more of the examples disclosed above, in some examples, wherein outputting, via the output device, the first prompt including one or more third characteristics different from the one or more first characteristics is in accordance with a determination that the movement of the input device relative to the object is movement of the input device towards the object. Additionally or alternatively to one of more of the examples disclosed above, in some examples, the one or more programs further include instructions for, in response to the movement of the input device relative to the object, in accordance with a determination that the movement of the input device relative to the object is movement of the input device away from the object, outputting, via the output device, the first prompt including one or more fourth characteristics different from the one or more first characteristics and different from the one or more third characteristics in accordance with the movement of the input device relative to the object. Additionally or alternatively to one of more of the examples disclosed above, in some examples, the one or more second characteristics include audio simulated to emanate from a location in the physical environment with a predetermined spatial orientation relative to the input device. Additionally or alternatively to one of more of the examples disclosed above, in some examples, the location in the physical environment corresponds to a physical location of the object in the physical environment. Additionally or alternatively to one of more of the examples disclosed above, in some examples, the one or more first characteristics of the first prompt include an audio cue comprising one or more non-verbal sounds. Additionally or alternatively to one of more of the examples disclosed above, in some examples, outputting the first prompt includes, while the input device and the object have a first spatial relationship in the physical environment, outputting a first sound simulated to emanate from a first location in a field of view of the input device and a second sound simulated to emanate from a second location associated with a location of the object with a third characteristic. Additionally or alternatively to one of more of the examples disclosed above, in some examples, while the input device and the object have a second spatial relationship in the physical environment different from the first spatial relationship, outputting a second sound simulated to emanate from a third location in the field of view of the input device and a fourth sound simulated to emanate from a fourth location associated with the location of the object with a fourth characteristic different from the third characteristic. Additionally or alternatively to one of more of the examples disclosed above, in some examples, wherein outputting the first prompt is in accordance with a determination that one or more second criteria different from the one or more first criteria are satisfied. Additionally or alternatively to one of more of the examples disclosed above, in some examples, the one or more programs further include instructions for, in accordance with a determination that the one or more second criteria are not satisfied, outputting, via the output device, a third prompt including one or more third characteristics. Additionally or alternatively to one of more of the examples disclosed above, in some examples, the one or more third characteristics prompt the user to move the input device in a predefined motion irrespective of a location of the object in the physical environment. Additionally or alternatively to one of more of the examples disclosed above, in some examples, the one or more programs further include instructions for, detecting, via the input device, a user input, and in response to detecting the user input, determining, via one or more processors, the action associated with the object based on the user input irrespective of whether or not the image satisfies the one or more first criteria.

Some examples of the disclosure are directed to a method for directing an input device associated with a wearable device at an object in a physical environment at a wearable device, the method comprising capturing, via the input device, an image of the physical environment that includes the wearable device, and in accordance with a determination that the image does not satisfy one or more first criteria with respect to the object in the physical environment, outputting, via an output device associated with the wearable device, a first prompt including one or more first characteristics. Additionally or alternatively to one of more of the examples disclosed above, in some examples, the one or more first characteristics prompt a user to direct the input device towards the object, and in accordance with a determination that the image satisfies the one or more first criteria with respect to the object, outputting, via the output device, a second prompt including one or more second characteristics, different from the one or more first characteristics. Additionally or alternatively to one of more of the examples disclosed above, in some examples, the one or more second characteristics indicate that the input device is directed at the object, and perform, via one or more processors associated with the wearable device, an action associated with the object. Additionally or alternatively to one of more of the examples disclosed above, in some examples, the input device further comprises a first electronic device configured to be worn on a first side of a user, and a second electronic device, different than the first electronic device, configured to be worn on a second side of a user, different than the first side of a user. Additionally or alternatively to one of more of the examples disclosed above, in some examples, wherein capturing the image of the physical environment that includes the wearable device includes capturing a first image, via an input device of the first electronic device, and capturing a second image, different than the first image, via an input device of the second electronic device, different than the input device of the first electronic device. Additionally or alternatively to one of more of the examples disclosed above, in some examples, in accordance with a determination that the first image does not satisfy one or more respective criteria with respect to the object in the physical environment, the one or more first characteristics of the first prompt cue the user to rotate the input device in a first direction, and in accordance with a determination that the second image does not satisfy the one or more respective criteria with respect to the object in the physical environment, the one or more first characteristics of the first prompt cue the user to rotate the input device in a second direction, different than the first direction. Additionally or alternatively to one of more of the examples disclosed above, in some examples, the first image satisfies a first criterion of the one or more respective criteria when a view of the physical environment included in the first image is less obstructed than a view of the physical environment included in the second image, and the second image satisfies the first criterion of the one or more respective criteria when the view of the physical environment included in the second image is less obstructed than the view of the physical environment included in the first image. Additionally or alternatively to one of more of the examples disclosed above, in some examples, the method further comprises detecting movement of the input device relative to the object, and in response to detecting the movement of the input device relative to the object, capturing, via the input device, a second image of the physical environment, different than the image of the physical environment, and outputting, via the output device, the first prompt including one or more third characteristics different from the one or more first characteristics in accordance with the movement of the input device relative to the object. Additionally or alternatively to one of more of the examples disclosed above, in some examples, wherein outputting, via the output device, the first prompt including one or more third characteristics different from the one or more first characteristics is in accordance with a determination that the movement of the input device relative to the object is movement of the input device towards the object. Additionally or alternatively to one of more of the examples disclosed above, in some examples, the method further comprises, in response to the movement of the input device relative to the object, and in accordance with a determination that the movement of the input device relative to the object is movement of the input device away from the object, outputting, via the output device, the first prompt including one or more fourth characteristics different from the one or more first characteristics and different from the one or more third characteristics in accordance with the movement of the input device relative to the object. Additionally or alternatively to one of more of the examples disclosed above, in some examples, the one or more second characteristics include audio simulated to emanate from a location in the physical environment with a predetermined spatial orientation relative to the input device. Additionally or alternatively to one of more of the examples disclosed above, in some examples, the location in the physical environment corresponds to a physical location of the object in the physical environment. Additionally or alternatively to one of more of the examples disclosed above, in some examples, the one or more first characteristics of the first prompt include an audio cue comprising one or more non-verbal sounds. Additionally or alternatively to one of more of the examples disclosed above, in some examples, wherein outputting the first prompt includes, while the input device and the object have a first spatial relationship in the physical environment, outputting a first sound simulated to emanate from a first location in a field of view of the input device and a second sound simulated to emanate from a second location associated with a location of the object with a third characteristic. Additionally or alternatively to one of more of the examples disclosed above, in some examples, while the input device and the object have a second spatial relationship in the physical environment different from the first spatial relationship, outputting a second sound simulated to emanate from a third location in the field of view of the input device and a fourth sound simulated to emanate from a fourth location associated with the location of the object with a fourth characteristic different from the third characteristic. Additionally or alternatively to one of more of the examples disclosed above, in some examples, wherein outputting the first prompt is in accordance with a determination that one or more second criteria different from the one or more first criteria are satisfied. Additionally or alternatively to one of more of the examples disclosed above, in some examples, the method further comprises, in accordance with a determination that the one or more second criteria are not satisfied, outputting, via the output device, a third prompt including one or more third characteristics. Additionally or alternatively to one of more of the examples disclosed above, in some examples, the one or more third characteristics prompt the user to move the input device in a predefined motion irrespective of a location of the object in the physical environment. Additionally or alternatively to one of more of the examples disclosed above, in some examples, the method further comprises detecting, via the input device, a user input, and in response to detecting the user input, determining, via one or more processors, the action associated with the object based on the user input irrespective of whether or not the image satisfies the one or more first criteria.

Some examples of the disclosure are directed to a non-transitory computer readable storage medium storing one or more programs, the one or more programs comprising instructions, which when executed by one or more processors of a wearable device, cause the wearable device to perform a method that includes capturing, via an input device associated with a wearable device, an image of a physical environment that includes the wearable device. Additionally or alternatively to one of more of the examples disclosed above, in some examples, in accordance with a determination that the image does not satisfy one or more first criteria with respect to an object in the physical environment, outputting, via an output device associated with the wearable device, a first prompt including one or more first characteristics. Additionally or alternatively to one of more of the examples disclosed above, in some examples, the one or more first characteristics prompt a user to direct the input device towards the object, and in accordance with a determination that the image satisfies the one or more first criteria with respect to the object, outputting, via the output device, a second prompt including one or more second characteristics different from the one or more first characteristics. Additionally or alternatively to one of more of the examples disclosed above, in some examples, the one or more second characteristics indicate that the input device is directed at the object. Additionally or alternatively to one of more of the examples disclosed above, in some examples, the wearable device performs, via one or more processors associated with the wearable device, an action associated with the object. Additionally or alternatively to one of more of the examples disclosed above, in some examples, the input device further comprises a first electronic device configured to be worn on a first side of a user, and a second electronic device, different than the first electronic device, configured to be worn on a second side of a user, different than the first side of a user. Additionally or alternatively to one of more of the examples disclosed above, in some examples, wherein capturing the image of the physical environment that includes the wearable device includes capturing a first image, via an input device of the first electronic device, and capturing a second image, different than the first image, via an input device of the second electronic device, different than the input device of the first electronic device. Additionally or alternatively to one of more of the examples disclosed above, in some examples, in accordance with a determination that the first image does not satisfy one or more respective criteria with respect to the object in the physical environment, the one or more first characteristics of the first prompt cue the user to rotate the input device in a first direction, and in accordance with a determination that the second image does not satisfy the one or more respective criteria with respect to the object in the physical environment, the one or more first characteristics of the first prompt cue the user to rotate the input device in a second direction, different than the first direction. Additionally or alternatively to one of more of the examples disclosed above, in some examples, the first image satisfies a first criterion of the one or more respective criteria when a view of the physical environment included in the first image is less obstructed than a view of the physical environment included in the second image, and the second image satisfies the first criterion of the one or more respective criteria when the view of the physical environment included in the second image is less obstructed than the view of the physical environment included in the first image. Additionally or alternatively to one of more of the examples disclosed above, in some examples, the one or more programs further including instructions for detecting movement of the input device relative to the object, and in response to detecting the movement of the input device relative to the object, capturing, via the input device, a second image of the physical environment, different than the image of the physical environment, and outputting, via the output device, the first prompt including one or more third characteristics different from the one or more first characteristics in accordance with the movement of the input device relative to the object. Additionally or alternatively to one of more of the examples disclosed above, in some examples, wherein outputting, via the output device, the first prompt including one or more third characteristics different from the one or more first characteristics is in accordance with a determination that the movement of the input device relative to the object is movement of the input device towards the object. Additionally or alternatively to one of more of the examples disclosed above, in some examples, the one or more programs further include instructions for, in response to the movement of the input device relative to the object, and in accordance with a determination that the movement of the input device relative to the object is movement of the input device away from the object, outputting, via the output device, the first prompt including one or more fourth characteristics different from the one or more first characteristics and different from the one or more third characteristics in accordance with the movement of the input device relative to the object. Additionally or alternatively to one of more of the examples disclosed above, in some examples, the one or more second characteristics include audio simulated to emanate from a location in the physical environment with a predetermined spatial orientation relative to the input device. Additionally or alternatively to one of more of the examples disclosed above, in some examples, the location in the physical environment corresponds to a physical location of the object in the physical environment. Additionally or alternatively to one of more of the examples disclosed above, in some examples, the one or more first characteristics of the first prompt include an audio cue comprising one or more non-verbal sounds. Additionally or alternatively to one of more of the examples disclosed above, in some examples, outputting the first prompt includes, while the input device and the object have a first spatial relationship in the physical environment, outputting a first sound simulated to emanate from a first location in a field of view of the input device and a second sound simulated to emanate from a second location associated with a location of the object with a third characteristic. Additionally or alternatively to one of more of the examples disclosed above, in some examples, while the input device and the object have a second spatial relationship in the physical environment different from the first spatial relationship, outputting a second sound simulated to emanate from a third location in the field of view of the input device and a fourth sound simulated to emanate from a fourth location associated with the location of the object with a fourth characteristic different from the third characteristic. Additionally or alternatively to one of more of the examples disclosed above, in some examples, outputting the first prompt is in accordance with a determination that one or more second criteria different from the one or more first criteria are satisfied. Additionally or alternatively to one of more of the examples disclosed above, in some examples, the one or more programs further include instructions for, in accordance with a determination that the one or more second criteria are not satisfied, outputting, via the output device, a third prompt including one or more third characteristics. Additionally or alternatively to one of more of the examples disclosed above, in some examples, the one or more third characteristics prompt the user to move the input device in a predefined motion irrespective of a location of the object in the physical environment. Additionally or alternatively to one of more of the examples disclosed above, in some examples, the one or more programs further including instructions for detecting, via the input device, a user input, and in response to detecting the user input, determining, via one or more processors, the action associated with the object based on the user input irrespective of whether or not the image satisfies the one or more first criteria.

The present disclosure contemplates that in some examples, the data utilized by the wearable device (e.g., wearable device 155, wearable device 255) can include personal information data that uniquely identifies or can be used to contact or locate a specific person. Such personal information data can include demographic data, content consumption activity, location-based data, telephone numbers, email addresses, social media ID's, home addresses, data or records relating to a user’s health or level of fitness (e.g., vital signs measurements, medication information, exercise information), date of birth, or any other identifying or personal information. Specifically, as described herein, one aspect of the present disclosure is tracking an object of interest to the user in a physical environment.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording and/or sharing of personal information data or images. In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

1. A wearable device comprising:
an input device;
an output device configured to provide one or more prompts to a user;
one or more processors;
memory; and
one or more programs, wherein the one or more programs are stored in the memory and configured to be executed by the one or more processors, the one or more programs including instructions for:
capturing, via the input device, an image of a physical environment that includes the wearable device;
in accordance with a determination that the image does not satisfy one or more first criteria with respect to an object in the physical environment, outputting, via the output device, a first prompt including one or more first characteristics wherein:
the one or more first characteristics prompt a user to direct the input device towards the object;
in accordance with a determination that the image satisfies the one or more first criteria with respect to the object:
outputting, via the output device, a second prompt including one or more second characteristics different from the one or more first characteristics, wherein:
the one or more second characteristics indicate that the input device is directed at the object; and
performing, via the one or more processors, an action associated with the object.

2. The wearable device of claim 1, wherein capturing the image of the physical environment that includes the wearable device includes capturing a first image and a second image, different than the first image, via the input device, wherein:
in accordance with a determination that the first image does not satisfy one or more respective criteria with respect to the object in the physical environment, the one or more first characteristics of the first prompt cue the user to rotate the input device in a first direction; and
in accordance with a determination that the second image does not satisfy the one or more respective criteria with respect to the object in the physical environment, the one or more first characteristics of the first prompt cue the user to rotate the input device in a second direction, different than the first direction.

3. The wearable device of claim 2, wherein the first image satisfies a first criterion of the one or more respective criteria when a view of the physical environment included in the first image is less obstructed than a view of the physical environment included in the second image, and the second image satisfies the first criterion of the one or more respective criteria when the view of the physical environment included in the second image is less obstructed than the view of the physical environment included in the first image.

4. The wearable device of claim 1, wherein the one or more programs further include instructions for:
detecting movement of the input device relative to the object; and
in response to detecting the movement of the input device relative to the object:
capturing, via the input device, a second image of the physical environment, different than the image of the physical environment; and
outputting, via the output device, the first prompt including one or more third characteristics different from the one or more first characteristics in accordance with the movement of the input device relative to the object.

5. The wearable device of claim 4, wherein outputting, via the output device, the first prompt including one or more third characteristics different from the one or more first characteristics is in accordance with a determination that the movement of the input device relative to the object is movement of the input device towards the object, and the one or more programs further include instructions for:
in response to the movement of the input device relative to the object:
in accordance with a determination that the movement of the input device relative to the object is movement of the input device away from the object, outputting, via the output device, the first prompt including one or more fourth characteristics different from the one or more first characteristics and different from the one or more third characteristics in accordance with the movement of the input device relative to the object.

6. The wearable device of claim 1, wherein the one or more second characteristics include audio simulated to emanate from a location in the physical environment with a predetermined spatial orientation relative to the input device.

7. The wearable device of claim 1, wherein outputting the first prompt includes:
while the input device and the object have a first spatial relationship in the physical environment, outputting a first sound simulated to emanate from a first location in a field of view of the input device and a second sound simulated to emanate from a second location associated with a location of the object with a third characteristic; and
while the input device and the object have a second spatial relationship in the physical environment different from the first spatial relationship, outputting a second sound simulated to emanate from a third location in the field of view of the input device and a fourth sound simulated to emanate from a fourth location associated with the location of the object with a fourth characteristic different from the third characteristic.

8. The wearable device of claim 1, wherein outputting the first prompt is in accordance with a determination that one or more second criteria different from the one or more first criteria are satisfied, and the one or more programs further include instructions for:
in accordance with a determination that the one or more second criteria are not satisfied, outputting, via the output device, a third prompt including one or more third characteristics, wherein:
the one or more third characteristics prompt the user to move the input device in a predefined motion irrespective of a location of the object in the physical environment.

9. A method for directing an input device associated with a wearable device at an object in a physical environment at a wearable device, the method comprising:
capturing, via the input device, an image of the physical environment that includes the wearable device;
in accordance with a determination that the image does not satisfy one or more first criteria with respect to the object in the physical environment, outputting, via an output device associated with the wearable device, a first prompt including one or more first characteristics wherein:
the one or more first characteristics prompt a user to direct the input device towards the object;
in accordance with a determination that the image satisfies the one or more first criteria with respect to the object:
outputting, via the output device, a second prompt including one or more second characteristics, different from the one or more first characteristics, wherein:
the one or more second characteristics indicate that the input device is directed at the object; and
performing, via one or more processors associated with the wearable device, an action associated with the object.

10. The method of claim 9, wherein capturing the image of the physical environment that includes the wearable device includes capturing a first image and a second image, different than the first image, via the input device, wherein:
in accordance with a determination that the first image does not satisfy one or more respective criteria with respect to the object in the physical environment, the one or more first characteristics of the first prompt cue the user to rotate the input device in a first direction; and
in accordance with a determination that the second image does not satisfy the one or more respective criteria with respect to the object in the physical environment, the one or more first characteristics of the first prompt cue the user to rotate the input device in a second direction, different than the first direction.

11. The method of claim 10, wherein the first image satisfies a first criterion of the one or more respective criteria when a view of the physical environment included in the first image is less obstructed than a view of the physical environment included in the second image, and the second image satisfies the first criterion of the one or more respective criteria when the view of the physical environment included in the second image is less obstructed than the view of the physical environment included in the first image.

12. The method of claim 9, further comprising:
detecting movement of the input device relative to the object; and
in response to detecting the movement of the input device relative to the object:
capturing, via the input device, a second image of the physical environment, different than the image of the physical environment; and
outputting, via the output device, the first prompt including one or more third characteristics different from the one or more first characteristics in accordance with the movement of the input device relative to the object.

13. The method of claim 12, wherein outputting, via the output device, the first prompt including one or more third characteristics different from the one or more first characteristics is in accordance with a determination that the movement of the input device relative to the object is movement of the input device towards the object, and the method further comprises:
in response to the movement of the input device relative to the object:
in accordance with a determination that the movement of the input device relative to the object is movement of the input device away from the object, outputting, via the output device, the first prompt including one or more fourth characteristics different from the one or more first characteristics and different from the one or more third characteristics in accordance with the movement of the input device relative to the object.

14. The method of claim 9, wherein the one or more second characteristics include audio simulated to emanate from a location in the physical environment with a predetermined spatial orientation relative to the input device.

15. The method of claim 9, wherein outputting the first prompt includes:
while the input device and the object have a first spatial relationship in the physical environment, outputting a first sound simulated to emanate from a first location in a field of view of the input device and a second sound simulated to emanate from a second location associated with a location of the object with a third characteristic; and
while the input device and the object have a second spatial relationship in the physical environment different from the first spatial relationship, outputting a second sound simulated to emanate from a third location in the field of view of the input device and a fourth sound simulated to emanate from a fourth location associated with the location of the object with a fourth characteristic different from the third characteristic.

16. The method of claim 9, wherein outputting the first prompt is in accordance with a determination that one or more second criteria different from the one or more first criteria are satisfied, wherein the method further comprises:
in accordance with a determination that the one or more second criteria are not satisfied, outputting, via the output device, a third prompt including one or more third characteristics, wherein:
the one or more third characteristics prompt the user to move the input device in a predefined motion irrespective of a location of the object in the physical environment.

17. A non-transitory computer readable storage medium storing one or more programs, the one or more programs comprising instructions, which when executed by one or more processors of a wearable device, cause the wearable device to perform a method that includes:
capturing, via an input device associated with a wearable device, an image of a physical environment that includes the wearable device;
in accordance with a determination that the image does not satisfy one or more first criteria with respect to an object in the physical environment, outputting, via an output device associated with the wearable device, a first prompt including one or more first characteristics wherein:
the one or more first characteristics prompt a user to direct the input device towards the object;
in accordance with a determination that the image satisfies the one or more first criteria with respect to the object:
outputting, via the output device, a second prompt including one or more second characteristics different from the one or more first characteristics, wherein:
the one or more second characteristics indicate that the input device is directed at the object; and
performing, via one or more processors associated with the wearable device, an action associated with the object.

18. The non-transitory computer readable storage medium of claim 17, wherein capturing the image of the physical environment that includes the wearable device includes capturing a first image and a second image, different than the first image, via the input device, wherein:
in accordance with a determination that the first image does not satisfy one or more respective criteria with respect to the object in the physical environment, the one or more first characteristics of the first prompt cue the user to rotate the input device in a first direction; and
in accordance with a determination that the second image does not satisfy the one or more respective criteria with respect to the object in the physical environment, the one or more first characteristics of the first prompt cue the user to rotate the input device in a second direction, different than the first direction.

19. The non-transitory computer readable storage medium of claim 18, wherein the first image satisfies a first criterion of the one or more respective criteria when a view of the physical environment included in the first image is less obstructed than a view of the physical environment included in the second image, and the second image satisfies the first criterion of the one or more respective criteria when the view of the physical environment included in the second image is less obstructed than the view of the physical environment included in the first image.

20. The non-transitory computer readable storage medium of claim 17, the one or more programs further including instructions for:
detecting movement of the input device relative to the object; and
in response to detecting the movement of the input device relative to the object:
capturing, via the input device, a second image of the physical environment, different than the image of the physical environment; and
outputting, via the output device, the first prompt including one or more third characteristics different from the one or more first characteristics in accordance with the movement of the input device relative to the object.

21. The non-transitory computer readable storage medium of claim 20, wherein outputting, via the output device, the first prompt including one or more third characteristics different from the one or more first characteristics is in accordance with a determination that the movement of the input device relative to the object is movement of the input device towards the object, and the one or more programs further include instructions for:
in response to the movement of the input device relative to the object:
in accordance with a determination that the movement of the input device relative to the object is movement of the input device away from the object, outputting, via the output device, the first prompt including one or more fourth characteristics different from the one or more first characteristics and different from the one or more third characteristics in accordance with the movement of the input device relative to the object.

22. The non-transitory computer readable storage medium of claim 17, wherein the one or more second characteristics include audio simulated to emanate from a location in the physical environment with a predetermined spatial orientation relative to the input device.

23. The non-transitory computer readable storage medium of claim 17, wherein outputting the first prompt includes:
while the input device and the object have a first spatial relationship in the physical environment, outputting a first sound simulated to emanate from a first location in a field of view of the input device and a second sound simulated to emanate from a second location associated with a location of the object with a third characteristic; and
while the input device and the object have a second spatial relationship in the physical environment different from the first spatial relationship, outputting a second sound simulated to emanate from a third location in the field of view of the input device and a fourth sound simulated to emanate from a fourth location associated with the location of the object with a fourth characteristic different from the third characteristic.

24. The non-transitory computer readable storage medium of claim 17, wherein outputting the first prompt is in accordance with a determination that one or more second criteria different from the one or more first criteria are satisfied, and the one or more programs further include instructions for:
in accordance with a determination that the one or more second criteria are not satisfied, outputting, via the output device, a third prompt including one or more third characteristics, wherein:
the one or more third characteristics prompt the user to move the input device in a predefined motion irrespective of a location of the object in the physical environment.
